(19) United States
(12) Patent Application Publication
(10) Pub. No.: US 2021/0037927 A1
(43) Pub. Date: Feb. 11, 2021

(54) MACHINE FOR ROUGHING SHOE SOLES

(71) Applicant: CERIM S.R.L., Milano (MI) (IT)

(72) Inventor: Luciano MERCALLI, Vigevano (PV) (IT)

(21) Appl. No.: 16/984,116

(22) Filed: Aug. 3, 2020

(30) Foreign Application Priority Data
Aug. 5, 2019 (IT) 102019000014031

(51) Int. Cl. A43D 37/00; A43D 119/00

(52) U.S. Cl. CPC A43D 37/005; A43D 119/00

(57) ABSTRACT

A machine (10) for roughing a shoe sole comprises a support (17) for a sole, a rouging head (14) and a movement system (13) for moving the roughing head (14) relative to the support (17) under the control of a control system (15) so as to follow with the roughing head (14) roughing trajectories on a sole placed in the support (17). The roughing head (14) comprises a radial roughing tool (42), motorized to rotate about its transverse axis (46), and an axial roughing tool (43), motorized to rotate about its longitudinal axis (44). The radial roughing tool (42) and the axial roughing tool (43) are mutually interchangeable by means of a selection actuator (49) controlled by the control system (15) so as to operate alternately on a sole in the support (17).

### RELATED APPLICATIONS

This application claims priority to Italian Application No. 102019000014031, filed Aug. 5, 2019, the teachings of which are incorporated herein by reference.

### DESCRIPTION

The present invention relates to a machine for roughing shoe soles.

In the sector for the production of shoes it is known that there exists the problem of having to suitably treat mechanically the surface of the sole before applying onto it the glue which will fix the sole to the bottom of the shoe.

Essentially it is generally required to perform a material removal operation so as to make the surface of the inner part of the sole suitably porous so that the following gluing operation may be performed in an efficient manner. Generally, this removal operation may be performed to a greater or lesser depth depending on the material which forms the sole and the technology used for production of the sole.

Depending on the amount of material to be removed, the removal operation may consist of a milling operation, performed with a suitable milling cutter, a rouging operation performed for example with a metal-wire roughing tool, or an abrasion or grinding operation performed with suitable abrasive paper (multiple-sheet discs, rollers, etc.).

Here, for the sake of easier description, the operation for removing material from the sole will be referred to by the generic term “roughing” and the tool used will be referred to by the generic term “roughing tool”. It is understood, however, that the “roughing” operation may also be a milling operation (usually in the case of where material is removed to a greater depth) or a grinding operation (usually in the case where a smaller amount of material is removed).

Over time automatic machines have been developed in order to carry out this “roughing” operation, but the results obtained are not always satisfactory and often manual work must be performed by an operator who manually passes the sole over a motorized roughing tool.

The problem arises in particular, for example, in the case of soles which have a raised edge. In fact, in the case of soles with a raised edge, an automatic machine according to the prior art does not manage to roughen in a satisfactory manner the surface of the sole situated between the raised edge and often it is preferred to assign the operation to a skilled operator who manually performs the roughing operation or at least manually finishes off the roughing operation performed by an automatic machine. In some cases it is also necessary to perform separately the manual operations for roughing the bottom and the edge of the sole, using two different motorized manual tools, resulting in further wasted time.

The manual operation, however, requires in any case that an operator should have sufficient experience and expertise and, in this case, there is the drawback of low productivity compared to a machine and, in particular, a lack of uniformity in the finishing of different soles. Moreover, soles made of moulded plastic are particularly delicate with regard to the roughing operations and must undergo uniform or only superficial roughing to avoid damage. For example, it is sufficient for the operator to press the roughing tool too firmly at a given point on the sole for it to be damaged as result, such that the sole must be discarded before the following operation of gluing it to the shoe.

Even in the case of particularly skillful operators, the probability of error during manual finishing remains relatively high, also because the moulded soles are generally softer and less able to withstand the penetration of a manually operated roughing tool. These manual roughing operations therefore give rise to a large number of production rejects, said rejects having a not insignificant impact on the final cost of the shoes. Furthermore, the manual operation results in the operator being exposed to the dust generated by roughing, with consequent risks for the health of the operator.

The general object of the present invention is to overcome the problems of the prior art by providing an automatic roughing machine which is able to ensure satisfactory roughing of the soles, also for example in the case of delicate soles and/or soles with a raised edge.

In view of this object the idea which has occurred is to provide, according to the invention, a machine for roughing a shoe sole, comprising a support for a sole, a rouging head and a movement system for moving the roughing head relative to the support under the control of a control system so as to follow with the roughing head roughing trajectories on a sole placed in the support, characterized in that the roughing head comprises a radial roughing tool, motorized to rotate about its transverse axis, and an axial roughing tool, motorized to rotate about its longitudinal axis, the radial roughing tool and the axial roughing tool being mutually interchangeable by means of a selection actuator controlled by the control system so as to operate alternately on a sole in the support.

In order to illustrate more clearly the innovative principles of the present invention and its advantages compared to the prior art, an example of embodiment applying these principles will be described below with the aid of the accompanying drawings. In the drawings:

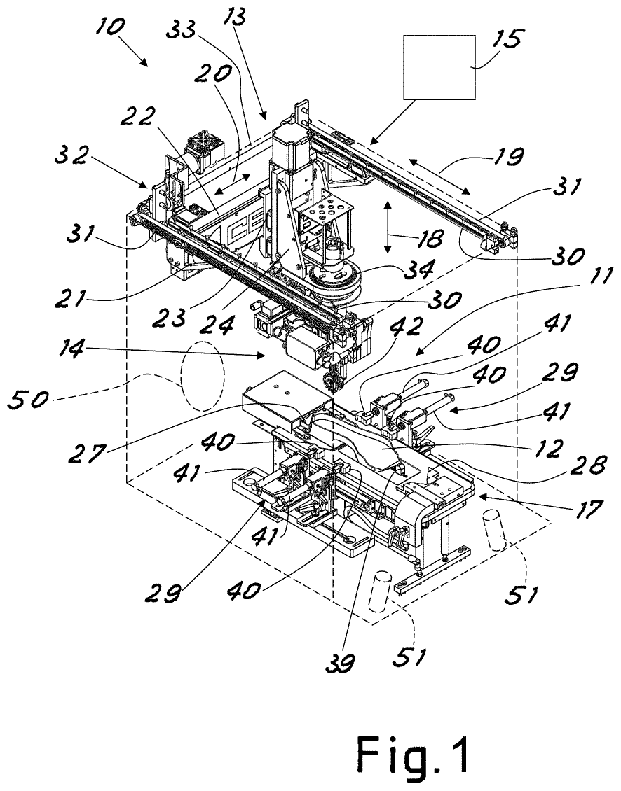

FIG. 1 shows a schematic perspective view of a machine provided in accordance with the invention;

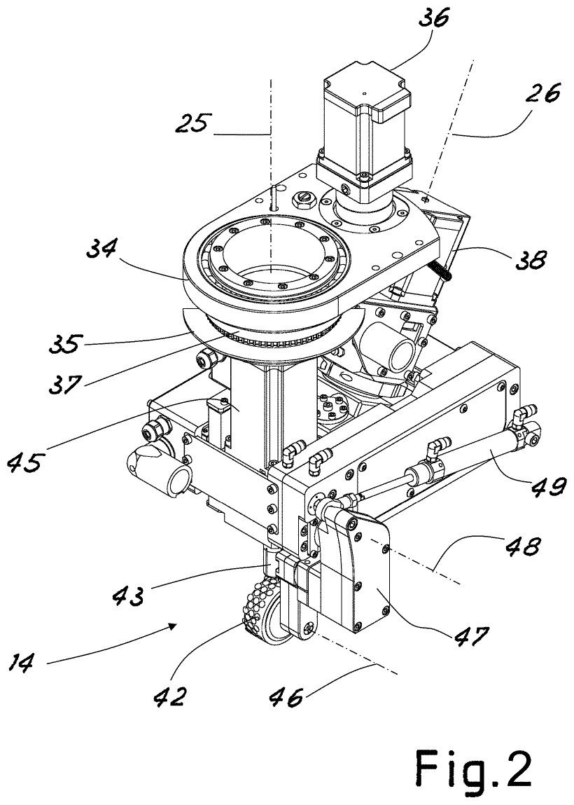

FIG. 2 shows a partial and perspective schematic view of an operating head of the machine according to FIG. 1;

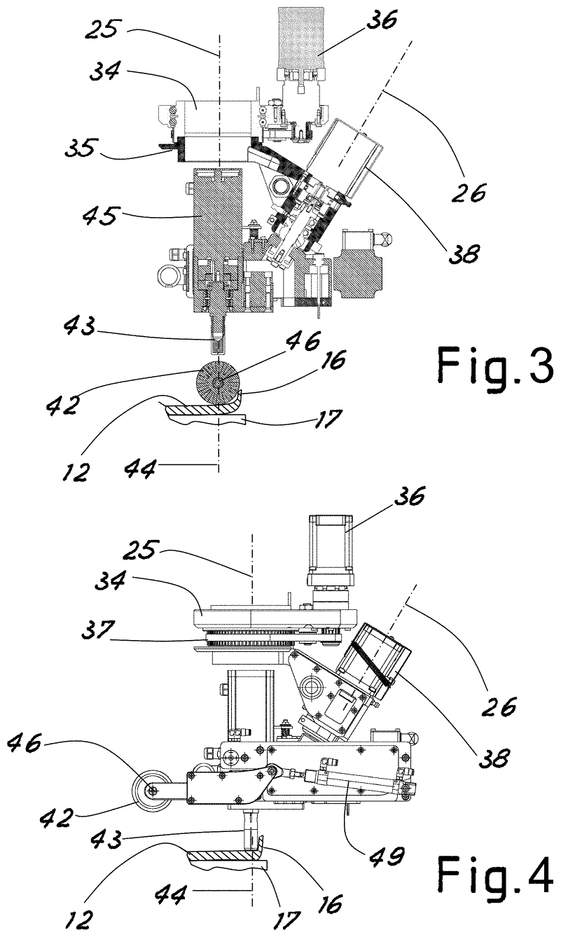

FIG. 3 shows a partial and cross-sectioned schematic view of the head according to FIG. 2, with the tools of the head in a first operative condition;

FIG. 4 shows a partial schematic view of the head according to FIG. 2, with the tools in a second operative condition;

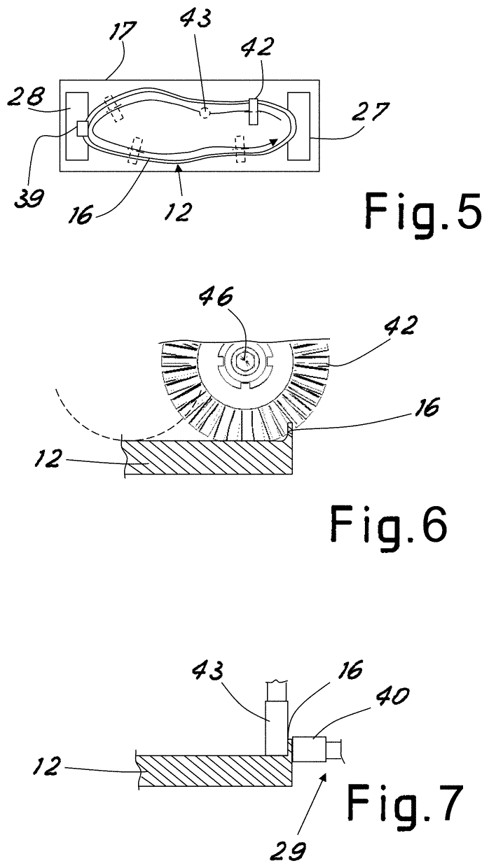

FIG. 5 is a schematic and partial plan view of a part supporting the sole in the machine according to FIG. 1 during a possible machining movement of the machine tools;

FIGS. 6 and 7 show schematic, enlarged and partially sectioned perspective views of possible roughing operations which can be obtained with the tools of the machine according to the invention.

With reference to the figures, FIG. 1 shows a possible embodiment of a machine according to the invention, denoted generically by 10. For the sake of clarity, part of the support and housing structure of the machine is shown only in broken lines in FIG. 1.

The machine 10 comprises a zone 11 for receiving a sole 12 to be roughened and a motorized system 13 for moving a roughing head 14 along suitable trajectories on the sole present in the zone 11. The roughing operation is advantageously used to prepare a sole for the following operation involving gluing of the same sole so as to fix it onto the bottom of a shoe.

The movement may be performed in an automated manner owing to a computerized control system 15 known per se (for example a suitably programmed microprocessor system).

The sole 12 is locked in the machining zone 11 by means of a suitable support 17.

The head 14 and the support 17 are movable relative to each other by means of drives which allow the head 14 to follow the desired trajectories. The movements may be for example interpolated by the control system 15 so as to follow desired trajectories, in a manner substantially known per se to the person skilled in the art.

Essentially, the movement system may comprise the necessary degrees of freedom of movement in space so as to follow desired trajectories with the desired inclination of the end of the roughing head 14 with respect to the sole on the support 17. For example, advantageously four or five degrees of freedom in the relative positioning of the head 14 and support 17 may be envisaged.

For example, the movement system may be advantageously a Cartesian movement system along three Cartesian axes plus two axes of rotation, so as to provide a movement system with five axes.

In particular, as schematically shown in FIG. 1, an advantageous structure may envisage drives for the sliding movement of the head, relative to the support 17, along three orthogonal Cartesian axes 18, 19, 20. Advantageously, the movement along one of the Cartesian axes (for example the axis 18 in FIG. 1) will consist in a distancing/approach movement of the head 14 in a direction generally perpendicular to the planar surface of a sole 12 on the support 17.

The movement along two orthogonal axes (the axes 19, 20 in FIG. 1) may be in a plane generally parallel to the extension of the planar surface of a sole 12 on the support 17.

In particular, in the example of embodiment shown in the figures, a motorized carriage 21 moves along the axis 19 and supports a rail 22 which extends along the axis 20. A motorized carriage 23 in turn slides along the rail 22 and has a further motorized carriage 24 for the movement of the head 14 along the axis 18.

In this way the controlled movement of the head 14 along the three orthogonal Cartesian axes 18, 19, and 20 may be easily obtained.

Alternative embodiments may in any case be easily imagined by the person skilled in the art. For example, the rail 22 may be designed to move on the carriage 21 along the axis 18, so as to move vertically the head 14 without the need for the carriage 24.

For the movement of the carriage 21 along the axis 19, a pair of parallel rails 30, which are arranged on the top sides of the machine and directed along the axis 19, is advantageously used. Respective lateral ends of the carriage 21 slide on the two rails 30, said ends being acted on by two transmissions 31 which are advantageously formed with toothed belts and motorized in synchronism by means of a single electric gearmotor 32 with a transmission shaft 33 connected in common between the two transmissions 31.

Advantageously, the head 14 is mounted in the machine so as to have desired inclination movements with respect to the sole 12 on the support 17.

A possible embodiment of this is visible for example in FIG. 2 and more clearly in FIGS. 3 and 4.

As can be seen in these figures, the head 14 may be for example provided with a first motorized axis of rotation 25, arranged parallel to the sliding axis 18, so as to allow a directional moment of the head generally in the plane of the sole (as will be clarified below).

Advantageously, the head 14 will also comprise a second motorized axis of rotation 26, arranged inclined with respect to the axis 25. As may be easily imagined by the person skilled in the art, the combination of coordinated rotations of the two axes 25 and 26 thus allows the inclination of head 14 so as to direct it spatially while it follows the desired trajectory on the sole.

In the embodiment described here by way of example, the four axes 18, 19, 20 and 25 essentially allow positioning of the head, while the skew axis 26 allows inclination of the head in the plane of the sole.

For rotation of the head 14 about the axis 25 a support 34 may be provided, said support being fixed to the displacement carriage 24 and supporting a thrust bearing 35 rotatable about the axis 25 by means of a gearmotor 36 and a transmission 37, advantageously of the toothed belt type.

As can be seen in the cross-section of FIG. 3, the thrust bearing 35 supports in turn the second inclined axis 26 which is motorized with a gearmotor 38 and which supports the head 14 so as to rotate it, upon command, about the axis 26.

All the motorized movements of the machine may be controlled by the known electronic control unit 15 in which, for example, the trajectories to be followed may be programmed, depending on the model and shoe size of the sole being machined, as is well-known to the person skilled in the art. A suitable known man/machine interface, not shown, (for example provided with keyboard and display or touch screen display) may also be provided for entering the trajectory data, in the unit 15 (also by means of self-learning), so as to start or stop the various operations of the machine, perform tests and calibrations, etc., as known to the person skilled in the art for this type of machine.

Referring again to FIG. 1, the support 17 may also comprise gripping members 27, 28 arranged opposite each other and suitably shaped so as to lock between them a sole 12 resting on its front and rear ends (as schematically visible also in FIG. 5), so as to leave free from obstacles the surface of the sole which is to be roughened.

The gripping members 27 and 28 may be advantageously two shaped jaws which are movable towards each other (manually or preferably by means of a motor) so as to clamp the sole between them.

The system for locking the sole on the support 17 may also be different from that shown. For example, it may comprise a known suction system beneath the sole or other known systems which ensure the retention and stability of the sole 12 in the support 17. Obviously, the support 17 may be shaped so as to receive soles with a configuration which is not necessarily flat (for example also with a very high heel), as may be easily imagined by the person skilled in the art.

Advantageously, the locking system may also be formed by or comprise lateral locking systems 29 which may be in addition to or replace the gripping members 27 and 28. As will become clear below, the lateral locking systems 29 may also serve to prevent the flexing of a raised side edge of the sole during the roughing operations.

The lateral locking systems 29 may comprise advantageously lateral buffers 40 pressing against the side edge of the sole, provided with linear movement actuators 41 for exerting the thrust towards the sole present in the support 17. For example, as can be seen in FIG. 1, these locking systems 29 may comprise on each side of the sole two lateral pressing buffers 40 (each with its own movement actuator 41) spaced in the heel-to-toe direction.

The support 17 may also comprise a further movable element 39 which is motorized so as to project, upon command, upwards and press against the toe end of the sole. This is able to prevent for example, during the roughing operations, the outwards flexing of an edge, directed upwards, at the toe end of the sole For example, in some sports shoes the sole has on the toe end a protection tongue which projects upwards and which must be roughened for gluing onto the toe of the shoe.

The movable element 39 may be used to keep this tongue in a substantially vertical position while it undergoes in the machine 10 the roughing action.

The adjustment of the machine according to the shoe size (namely the size of the sole along its length from heel to toe) may be advantageously performed by means of the motorized movement of one or both the gripping members 27 or 28. For example, this adjustment may be performed by means of a suitable motorized displacement by the rear gripping member 27.

FIGS. 2, 3 and 4 show in greater detail the roughing head 14.

This head 14 comprises a radial rotating roughing tool 42 and an axial rotating roughing tool 43 (also referred to as a “candle roughing tool”).

The radial roughing tool 42 is intended to rotate in a motorized manner with its radial perimeter against the sole, as schematically shown in FIG. 3.

The axial roughing tool 43 is instead intended to rotate in a motorized manner with its lateral surface and its front end against the sole, as schematically shown in FIG. 4.

In particular, the axial roughing tool 43 may have an axis of rotation 44 (for example operated by a gearmotor 45) which with the rotation of the head about the inclined axis 26 may be positioned so as to coincide with the axis of rotation 25 of the head.

The radial roughing tool 42 may have an axis of rotation 46 (for example operated by a gearmotor 47) which is transverse to the axis of rotation 44 of the axial roughing tool and, preferably, with the radial roughing tool 42 which is positioned in a plane which contains the axis 44.

As can be clearly seen in FIG. 3, in a first operative condition of the head 14, the radial roughing tool 42 is positioned in front of the axial roughing tool such that the radial roughing tool 42 is in an operative position and the axial roughing tool 43 is not operative. In this first operative condition of the head 14, the machine 10 may use the radial roughing tool 42 to perform roughing of the sole 12 present on the support 17.

As can be clearly seen in FIG. 4, in a second operative condition of the head 14, the radial roughing tool 42 is displaced far from the axis 44 of the axial roughing tool 43 such that the radial roughing tool 42 is in a non-operative position and the axial roughing tool 43 becomes operative. In this second operative condition of the head 14, the machine 10 may use the axial roughing tool 42 to perform roughing of the sole 12 present on the support 17.

The movement of the radial roughing tool 42 between its operative position shown in FIG. 3 and its non-operative position shown in FIG. 4 may be performed by using a movement actuator, operation of which is advantageously controlled by the control system 15, so as to ensure automatic switching over between roughing performed with the tool 42 and roughing performed with the tool 43.

Preferably, the movement of the radial roughing tool 42 between the operative position and non-operative position is performed by means of rotation about an axis 48 by means of an actuator 49. The axis 48 may be advantageously transverse to the plane of the roughing tool 42 and therefore parallel to the axis 46 of the roughing tool 42.

As can be clearly seen in FIG. 3, the radial roughing tool 42 in its operative position is advantageously at a small distance from the axial roughing tool 43 so that it is situated underneath it without touching it.

The fact that in its operative position the radial roughing tool 42 is substantially aligned with the axis 44 of the axial roughing tool 43 facilitates the movement of the head so as to follow with either roughing tool the trajectories along the sole in the support 17. This facilitates also the task which must be performed by the control unit 15 of following the desired trajectories on the sole with either roughing tool.

FIG. 5 shows in schematic form a possible movement of the roughing tools 42 and 43 on a sole 12 in the support 17. The radial roughing tool 42 may be moved along the edge of the sole, being kept directed with its surface substantially perpendicular to the edge of the sole and with the axis of the roughing tool directed the same way as the movement trajectory along the edge of the sole. As can be seen in FIG. 6, this movement allows roughing of the perimeter of the bottom face of the sole (namely the face of the sole which will be fitted together with the bottom of the shoe) and, if present, at least part of a raised edge 16 of the sole. The radial roughing tool 42 may also be used to roughen rapidly other parts of the bottom face of the sole (as shown in broken lines in FIG. 6) and, for example, also the entire bottom face of the sole, also by differently directing the radial roughing tool (for example, with the surface directed parallel to the heel-to-toe extension of the sole) and with a different movement trajectory (for example transverse to the sole, in zig-zag fashion, with successive parallel passes, etc.) and also with different inclinations of the axis 44 (for example so as to follow the heightwise progression of the sole).

FIG. 5 also shows in schematic form a possible movement of the axial roughing tool 43 (in broken lines) along the edge of the sole. As can be clearly seen also in FIG. 7, the axial roughing tool may be kept with its end part against the bottom of the sole and/or with its side surface against a side edge 16 of the sole. This is particularly useful in the case of soles which have a side edge which is raised at right angles with respect to the bottom of the sole.

FIG. 7 also shows a possible action of one of the lateral locking systems 29 for pressing against the outer side of the raised edge 16 of the sole, so as to oppose the thrust exerted laterally by the axial roughing tool 43. This prevents undesirable flexing of the side edge of the sole during the roughing operations. The same effect can be obtained on the toe end of the sole by means of the movable element 39. In the case where the movable element 39 is used, the locking element 28 may be moved away and the sole may be kept in position by means of alternative locking means (for example vacuum means underneath the sole) and/or by means of the lateral locking elements 29.

Alternatively or in addition the movable element 39 may project from the inside of the front locking element 28.

The opposing action provided by the lateral elements 29 and/or by the movable element 39 may be obviously used also with the radial roughing tool 42.

Although the axial roughing tool 43 advantageously allows suitable roughing of the edge between the bottom and raised edge of the sole, in the case where, for example, it cannot be reached by the circular perimeter of the radial roughing tool 42, the axial roughing tool may also be used to roughen other parts of the bottom face of the sole, if required, also using different movement trajectories (for example a trajectory transverse to the sole, in zig-zag fashion, with successive parallel passes, etc.) and also with different inclinations of the axis 44.

For example, the axial roughing tool may be used to machine the bottom of the sole and the edge between the bottom and the raised edge (this axial roughing tool may also perform a more or less deep milling operation), while the radial roughing tool may machine the raised edge, also without touching the bottom of the sole and with an action lighter than that of the axial roughing tool.

The axial roughing tool may also take the form of a milling cutter with machining surface (for example diamond-coated and/or Widia) underneath and along the side over a certain height (for example 5/10/15 mm etc.) depending on the machining height which is required for the edge, so as to mill the bottom, the edge between bottom and raised edge and also the raised edge, along the whole or part thereof, depending on the height of the lateral machining surface.

Owing to the flexibility of the machine described, if the sole does not have a particularly complicated raised edge, it might also not be necessary to use the radial roughing tool for the edge.

Owing to the programmability of the machine via the control system 15, it also possible for example to perform with the same roughing tool several passes over the sole. For example with the axial roughing tool it is possible to perform a first pass in order to machine the bottom, edge and part of the edge and then, with the second pass, machine the remainder of the raised edge, applying more force on the edge itself and inclining the tool, if necessary.

The same may also be done with the radial roughing tool, provided that the sole has a raised edge with a corner edge which is not excessively pronounced, so as to machine edge and bottom at the same time.

To summarize, with the same machine according to the invention, it is for example possible to perform various types of machining operations depending on requirements, preferences and type of sole.
only axial roughing (milling);
only radial roughing (roughing);
different combinations of the above machining operations.

Furthermore, as can be clearly seen in broken lines in FIG. 1, the automatic machine according to the invention may be made with a totally or partially closed design, having suitable side walls for suitably containing the dust produced by the roughing operations. Advantageously, suction mouths (indicated generically by 50 in FIG. 1) may also be provided for removal of the dust from the machining zone inside the machine. Advantageously, said suction mouths 50 may be provided with filters and vacuum sources, as may be now easily imagined by the person skilled in the art, and perform suction from the inside of the machine casing. Moreover, the front surface of the machine (via which the operator may insert a sole onto the support in the machining zone and then remove it after roughing) may be open or comprise a closing hatch. Advantageously, in particular in the case where the front surface is left with an opening, suitable sources 51 may be provided for emitting an air jet which is directed so as to form an air barrier in front of the support 17 and thus prevent the dust from escaping during machining and/or loading/unloading of a sole. The air jets emitted from the sources 51 may also be directed towards the support for cleaning the roughing zone of the machine and/or for pushing the dust towards the suction mouths 50.

At this point it is clear how the objects of the invention have been achieved.

With a machine according to the invention it is possible to perform with precision the roughing operations on soles, including those which are particularly delicate, by choosing automatically either roughing tool depending on the requirements and/or the particular zone or form of sole undergoing roughing. The control system 15 may be easily programmed so as to follow the desired trajectories with the desired roughing tool in order to obtain precise, uniform and suitable roughing of all parts of the sole, without the need for an operator, except for loading and unloading of the soles onto/from the support 17. The radial roughing tool allows the machine to perform the roughing also of zones which cannot be reached by the axial roughing tool and vice versa. The machine may therefore be easily programmed to change alternately the roughing tool which is operative in order to operate with the necessary delicate action and precision on all the surfaces of a sole which require roughing.

The machine, according to the invention, allows satisfactory roughing to be carried out on soles also with a very high edge, soles with differences in height along the edge, soles with internal ribs, soles with lined edges, flat soles, welted soles, etc.

The direction of rotation of the radial roughing tool may also be easily reversed (also by only rotating the surface of the radial roughing tool through 180 degrees). Alternatively or in addition, it is also possible to reverse quickly the rotation of the brush by reversing the direction of rotation of the gearmotor 47, from counter-clockwise to clockwise and vice versa, even dynamically during execution of the profile. As a result the roughing action may be rapidly adapted also to specific needs and forms of the sole.

Obviously the description given above of embodiments applying the innovative principles of the present invention is provided by way of example of these innovative principles and must therefore not be regarded as limiting the scope of the rights claimed herein.

For example, the movement structure of the head and the structure of the head itself may be different from that shown for moving the roughing tools in space. For example a machine with motorized axes arranged differently or with a different mechanism may be used, as may be now easily imagined by the person skilled in the art.

For example, the movement may be performed so that the degrees of freedom required may be obtained with one movement of the single head 14, keeping the support 17 stationary in the machine, or by means of a combination of relative movements of the head 14 and support 17.

For example, one or two orthogonal axes for movement in a plane (for example the axes 19 and 20 according to FIG. 1) may be obtained by moving the support 17 underneath the head 14, which is in turn moved along further axes in order to obtain the desire full, mutual, relative movement of head and support, as may be easily imagined by the person skilled in the art.

Also other known systems for machining footwear may be incorporated during the specific implementation of the characteristic features of the present invention. For example, the machine may be a combined machine, provided for example with a roughing station according to the invention and a known station for dispensing glue onto the roughened sole.

The roughing tools may be made using various known systems for obtaining a radial roughing tool and an axial roughing tool. In particular, as may also be understood from the figures, the radial roughing tool may be formed by a substantially rigid or elastically yielding cylinder, with an abrasive side surface, or may be formed by a set of abrasive elements which are directed radially towards the outside of a central axial core. In this latter case the abrasive elements may be formed by thread-like elements of suitable material (for example metal wires) or abrasive sheets (for example emery cloth), etc.

The axial roughing tool may also be formed for example by a substantially rigid or elastically yielding cylinder with a side and front surface which is lined with suitable abrasive material or is also composed of a plurality of radial and/or axial elements.

Both the axial roughing tool and the radial roughing tool may also be chosen with a different abrasive action depending on the result which is to be obtained and/or depending on the delicate nature of the soles to be roughened.

1. A machine for roughing a shoe sole, comprising a support for a sole, a roughing head and a movement system for moving the roughing head relative to the support under the control of a control system so as to follow with the roughing head roughing trajectories on a sole placed in the support, characterized in that the roughing head comprises a radial roughing tool, motorized to rotate about its transverse axis, and an axial roughing tool, motorized to rotate about its longitudinal axis, the radial roughing tool and the axial roughing tool being mutually interchangeable by means of a selection actuator controlled by the control system so as to operate alternately on a sole in the support.

2. The machine according to claim 1, characterized in that, to achieve the interchangeability of the radial roughing tool and the axial roughing tool for their alternate action on a sole in the support, the radial roughing tool is supported to be movable by means of the selection actuator between an operative position in front of the axial roughing tool and a non-operative position removed from said operative position.

3. The machine according to claim 2, characterized in that, for the movement between the operative position and the non-operative position, the radial roughing tool is supported on the roughing head so as to be rotatable about an axis of rotation by means of the selection actuator.

4. The machine according to claim 3, characterized in that the axis of rotation is arranged parallel to the transverse axis of the radial roughing tool and/or transverse to the longitudinal axis of the axial roughing tool.

5. The machine according to claim 2, characterized in that the longitudinal axis of the axial roughing tool intersects the transverse axis of the radial roughing tool when the radial roughing tool is in its operative position.

6. The machine according to claim 1, characterized in that the support comprises gripping members arranged opposite each other and intended to lock a sole between them by clamping it between a front end and a rear end thereof.

7. The machine according to claim 1, characterized in that the support comprises lateral locking systems which are intended to rest on corresponding side edges of a sole seated in the support.

8. The machine according to claim 1, characterized in that the support comprises a movable element which is intended to rest on a corresponding raised front edge of a sole seated in the support.

9. The machine according to claim 1, characterized in that the movement system has four or more axes.

10. The machine according to claim 1, characterized in that the movement system comprises a motorized movement along three orthogonal Cartesian axes and two rotations about mutually inclined axes of rotation.

11. The machine according to claim 10, characterized in that, for an angular position of the roughing head about one of the mutually inclined axes of rotation , the other axis of the mutually inclined axes of rotation coincides with the longitudinal axis of rotation of the axial roughing tool.

12. The machine according to claim 10, characterized in that one of the mutually inclined axes of rotation is parallel to one of the orthogonal Cartesian axes.

13. The machine according to claim 12, characterized in that such an axis of the mutually inclined axes of rotation is substantially perpendicular to a sole seated in the support.

14. The machine according to claim 1, characterized in that the radial roughing tool is formed by a substantially rigid or elastically yielding cylinder with an abrasive side surface or by a set of abrasive elements directed radially towards the outside of a central axial core.

15. The machine according to claim 1, characterized in that the axial roughing tool may be formed by a substantially rigid or elastically yielding cylinder with a side and front surface lined with abrasive material, or by a plurality of radial and/or axial elements.

16. The machine according to claim 1, further comprising suction mouths for removal of dust produced by the roughing and/or sources emitting an air jet for forming an air barrier in front of the support and/or for cleaning the area of the support.
